(19) United States
(12) Patent Application Publication
(10) Pub. No.: US 2022/0242390 A1
(43) Pub. Date: Aug. 4, 2022

(54) ENERGY MANAGEMENT METHOD AND SYSTEM FOR HYBRID ELECTRIC VEHICLE

(71) Applicant: SHANDONG INSTITUTE OF ADVANCED TECHNOLOGY, CHINESE ACADEMY OF SCIENCES CO., LTD, Shandong (CN)

(72) Inventors: Weimin LI, Shandong (CN); Haibin WANG, Shandong (CN); Lijuan LI, Shandong (CN); Jingjing ZHANG, Shandong (CN)

(73) Assignee: SHANDONG INSTITUTE OF ADVANCED TECHNOLOGY, CHINESE ACADEMY OF SCIENCES CO., LTD, Shandong (CN)

(21) Appl. No.: 17/617,595

(22) PCT Filed: Jul. 7, 2020
(86) PCT No.: PCT/CN2020/100569

§ 371 Date: Dec. 9, 2021

(30) Foreign Application Priority Data
Feb. 13, 2020 (CN) 202010090351.1

(51) Int. Cl. B60W 20/10; B60W 40/105; B60W 50/00

(52) U.S. Cl. CPC B60W 20/10; B60K 6/46; B60W 50/00; B60W 40/105

(57) ABSTRACT

An energy management method for a hybrid electric vehicle (HEV) includes: acquiring a state variable of an HEV; determining a speed of the HEV at a next moment by using a Markov model; according to a speed at a current moment and an acceleration at the current moment so that determining required power of the HEV at the next moment; determining battery power of the HEV according to the required power of the HEV at the next moment and engine power so that constructing a dynamic model for battery charging/discharging; determining energy costs of the HEV according to the required power at the next moment; constructing an energy optimization scheduling model of the HEV according to the energy costs; and determining an energy management model of the HEV according to the energy optimization scheduling model and the dynamic model for battery charging/discharging, to precisely manage energy of the HEV.

This application claims priority to Chinese Patent Application No. 202010090351.1, filed with the National Intellectual Property Administration, PRC on Feb. 13, 2020 and entitled “ENERGY MANAGEMENT METHOD AND SYSTEM FOR HYBRID ELECTRIC VEHICLE”, which is incorporated herein by reference in its entirety.

### TECHNICAL FIELD

The present invention relates to the field of vehicle energy management, and in particular, to an energy management method and system for a hybrid electric vehicle (HEV).

### BACKGROUND

Although conventional vehicles with internal combustion engines facilitate the transportation, environmental pollution and energy shortages caused by the vehicles become increasingly prominent. Therefore, the development of a new generation of clean and energy-saving vehicles has become an inevitable trend and a development hot spot in the world. Hybrid electric vehicles (HEVs) not only have advantages of high efficiency and low emission of pure electric vehicles, but also have advantages of long driving mileage and fast fuel replenishment of conventional vehicles with internal combustion engines. Therefore, the HEVs are currently one of effective ways to solve excessive vehicle energy consumption and air pollution. An HEV control policy is used for solving the energy management issue during vehicle driving, to effectively use power according to driving demands, thereby realizing purposes of energy saving and environmental protection.

There are many energy management methods for conventional HEVs, and energy management methods used in the prior art mainly include the following methods:

1. A dynamic control method for an adaptive proportion integral derivative (PID) controller of an HEV based on improved gray prediction (Patent No. CN109635433A) is mainly to combine the gray prediction and adaptive PID control, and introduce a quadratic performance index into the tuning process of the PID controller, where weighting coefficients are automatically adjustable, thereby achieving optimal control of adaptive PID. However, randomness of the system is not taken into consideration in prediction made by the gray prediction model based on the exponential rate, and medium and long-term prediction accuracy is relatively low. In the actual control process, the error of the prediction accuracy easily causes deviation of the control amount, and even makes it difficult to achieve the purpose of optimizing the HEV control policy.

2. According to an energy management method and system based on a plug-in HEV (Patent No. CN108909702A), a long-term trajectory of the state of charge of a battery is generated by using a dynamic programming algorithm, a short-term future speed is predicted based on a neural network model, and allocation and management are performed on power output of an in-vehicle energy source. However, the energy of the battery is merely evenly outputted, and fuel economy is not considered, to keep the engine and the motor working in a high-efficiency range as much as possible.

In the driving process of a conventional HEV, the entire HEV system has nonlinearity, and the HEV speed has a time-varying feature. Therefore, it is difficult to achieve precise control of energy of the HEV based on the above energy management methods used in the prior art.

### SUMMARY

An objective of the present invention is to provide an energy management method and system for a hybrid electric vehicle (HEV), which can improve control precision for energy of the HEY.

To achieve the foregoing objective, the present invention provides the following solutions:

An energy management method for an HEV is provided, including:

acquiring a state variable of an HEV, the state variable including: a speed at a current moment, an acceleration at the current moment, and engine power;

determining, according to the speed at the current moment and the acceleration at the current moment, a speed of the HEV at a next moment by using a Markov model;

determining required power of the HEV at the next moment according to the speed of the HEV at the next moment;

determining battery power of the HEV according to the required power of the HEV at the next moment and the engine power;

constructing a dynamic model for battery charging/discharging according to the battery power;

determining energy costs of the HEV according to the required power at the next moment, the energy costs including fuel costs and costs of electric energy consumption;

constructing an energy optimization scheduling model of the HEV according to the energy costs; and

determining an energy management model of the HEV according to the energy optimization scheduling model and the dynamic model for battery charging/discharging, to manage energy of the HEY.

Optionally, the determining, according to the speed at the current moment and the acceleration at the current moment, a speed of the HEV at a next moment by using a Markov model specifically includes:

constructing a discrete grid space according to the speed at the current moment and the acceleration at the current moment and based on a quantity of first preset intervals;

acquiring a quantity of second preset intervals, the quantity of second preset intervals being a quantity of divided intervals of an acceleration of the speed at the next moment;

determining, according to the discrete grid space and the quantity of second preset intervals and by using the Markov model, a probability that the acceleration at the current moment changes to the acceleration of the speed at the next moment; and

determining the acceleration of the speed at the next moment according to the probability.

Optionally, the determining battery power of the HEV according to the required power of the HEV at the next moment and the engine power specifically includes:

acquiring power consumed by a friction brake of the HEV in a case of insufficient regenerative braking; and

determining, according to the required power of the HEV at the next moment, the engine power, and the power consumed by the friction brake, the battery power P_{ba}(k) of the HEV by using a formula P_{ba}(k)=P_{req}(k)−P_{eng}(k)+Pₘᵢₛₛ(k), where P_{req}(k) is the required power at the next moment, P_{eng}(k) is the engine power, and Pₘᵢₛₛ(k) is the power consumed by the friction brake.

Optionally, the dynamic model for battery charging/discharging is:

SOE(k+1)=SOE(k)−P_{ba}(k), where SOE(⋅) is the dynamic model for battery charging/discharging, P_{ba}(k) is the battery power, and k=−Δt/E_{ba}, Δt being a simulation step size, and E_{ba} being total battery energy.

Optionally, the energy optimization scheduling model of the HEV is:

min G=Σₜ₌₁ⁿ{ω₁Cₒᵢₗ(t)+ω₂Fₒᵢₗ(t)+ω₃M_{co}_{₂}(t)}, where G is an energy optimization target, Cₒᵢₗ(t) is the fuel costs, Fₒᵢₗ(t) is the costs of electric energy consumption, M_{co}_{₂}(t) is a lowest value of emission of carbon dioxide (CO₂), ω₁ is a weight of the fuel costs, ω₂ is a weight of the costs of electric energy consumption, ω₃ is a weight of the lowest value of the emission of carbon dioxide, ω₁+ω₂+ω₃=1, t is a moment, and n is a total quantity of moments.

An energy management system for an HEV is provided, including:

a state variable acquisition module, configured to acquire a state variable of an HEV, the state variable including: a speed at a current moment, an acceleration at the current moment, and engine power;

a speed determining module, configured to determine, according to the speed at the current moment and the acceleration at the current moment, a speed of the HEV at a next moment by using a Markov model;

a required power determining module, configured to determine required power of the HEV at the next moment according to the speed of the HEV at the next moment;

a battery power determining module, configured to determine battery power of the HEV according to the required power of the HEV at the next moment and the engine power;

a dynamic model construction module, configured to construct a dynamic model for battery charging/discharging according to the battery power;

an energy cost determining module, configured to determine energy costs of the HEV according to the required power at the next moment, the energy costs including fuel costs and costs of electric energy consumption;

an energy optimization scheduling model construction module, configured to construct an energy optimization scheduling model of the HEV according to the energy costs; and

an energy management model construction module, configured to determine an energy management model of the HEV according to the energy optimization scheduling model and the dynamic model for battery charging/discharging, to manage energy of the HEY.

Optionally, the speed determining module specifically includes:

a discrete grid space construction unit, configured to construct a discrete grid space according to the speed at the current moment and the acceleration at the current moment and based on a quantity of first preset intervals;

a second-preset-interval-quantity acquisition unit, configured to acquire a quantity of second preset intervals, the quantity of second preset intervals being a quantity of divided intervals of an acceleration of the speed at the next moment;

an acceleration probability determining unit, configured to determine, according to the discrete grid space and the quantity of second preset intervals and by using the Markov model, a probability that the acceleration at the current moment changes to the acceleration of the speed at the next moment;

an acceleration determining unit, configured to determine the acceleration of the speed at the next moment according to the probability; and

a speed determining unit, configured to determine the speed of the HEV at the next moment according to the acceleration of the speed at the next moment.

Optionally, the battery power determining module specifically includes:

a power-consumed-by-friction-brake acquisition unit, configured to acquire power consumed by a friction brake of the HEV in a case of insufficient regenerative braking; and

a battery power determining unit, configured to determine, according to the required power of the HEV at the next moment, the engine power, and the power consumed by the friction brake, the battery power P_{ba}(k) of the HEV by using a formula P_{ba}(k)=P_{req}(k)−P_{eng}(k)+Pₘᵢₛₛ(k), where P_{req}(k) is the required power at the next moment, P_{eng}(k) is the engine power, and Pₘᵢₛₛ(k) is the power consumed by the friction brake.

According to specific embodiments of the present invention, the present invention discloses the following technical effects:

According to the energy management method and system for an HEV disclosed in the present invention, a speed and required power at a next moment are predicted by using a state variable at a current moment, an energy optimization scheduling model and a dynamic model for battery charging/discharging are constructed according to the speed and the required power at the next moment, and an energy management model of an HEV is finally determined by using the energy optimization scheduling model and the dynamic model for battery charging/discharging, to precisely manage energy of the HEY.

### BRIEF DESCRIPTION OF THE DRAWINGS

To describe the technical solutions in the embodiments of the present invention or the existing technology more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of an energy management method for an HEV according to an embodiment of the present invention;

FIG. 2 is a schematic structural diagram of a current hybrid power system;

FIG. 3 is another working flowchart of an energy management method for an HEV according to an embodiment of the present invention;

FIG. 4 is a schematic diagram of a rolling solving process according to an embodiment of the present invention;

FIG. 5 is a schematic structural diagram of an energy management system for an HEV according to an embodiment of the present invention.

### DETAILED DESCRIPTION

The technical solutions of embodiments of the present invention are clearly and completely described below with reference to the accompanying drawings in the embodiments of the present invention. Obviously, the described embodiments are merely some rather than all of the embodiments of the present invention. All other embodiments obtained by a person of ordinary skill in the art based on the embodiments of the present invention without creative efforts shall fall within the protection scope of the present invention.

An objective of the present invention is to provide an energy management method and system for a hybrid electric vehicle (HEV), which can improve control precision for energy of the HEY.

To make the objectives, features, and advantages of the present invention more obvious and comprehensible, the present invention is further described in detail below with reference to the accompanying drawings and specific implementations.

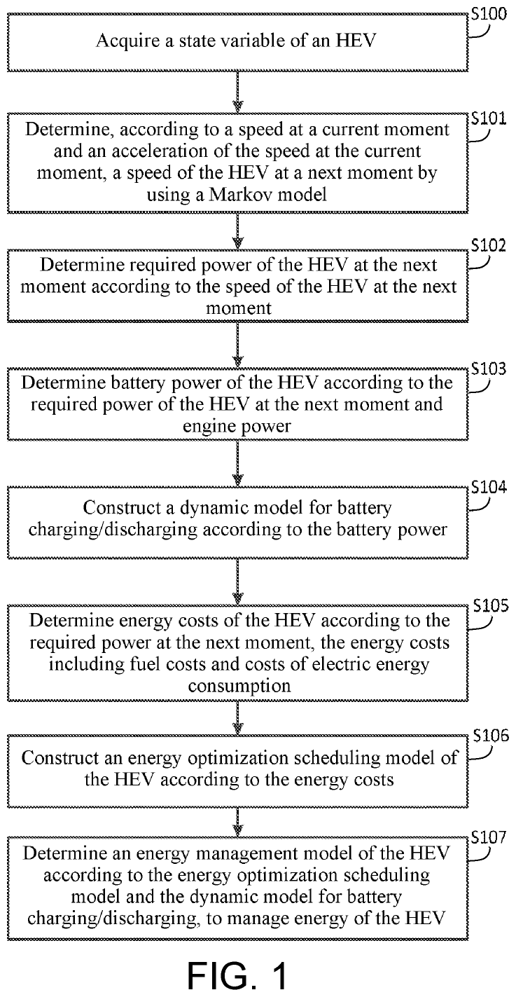

FIG. 1 is a flowchart of an energy management method for an HEV according to an embodiment of the present invention. As shown in FIG. 1, the energy management method for an HEV includes:

S100: Acquire a state variable of an HEV, the state variable including: a speed at a current moment, an acceleration at the current moment, and engine power.

S101: Determine, according to the speed at the current moment and the acceleration at the current moment, a speed of the HEV at a next moment by using a Markov model.

S102: Determine required power of the HEV at the next moment according to the speed of the HEV at the next moment.

S103: Determine battery power of the HEV according to the required power of the HEV at the next moment and the engine power.

S104: Construct a dynamic model for battery charging/discharging according to the battery power.

S105: Determine energy costs of the HEV according to the required power at the next moment, the energy costs including fuel costs and costs of electric energy consumption.

S106: Construct an energy optimization scheduling model of the HEV according to the energy costs.

S107: Determine an energy management model of the HEV according to the energy optimization scheduling model and the dynamic model for battery charging/discharging, to manage energy of the HEY.

In S101, a process of the determining, according to the speed at the current moment and the acceleration at the current moment, a speed of the HEV at a next moment by using a Markov model specifically includes:

constructing a discrete grid space according to the speed at the current moment and the acceleration at the current moment and based on a quantity of first preset intervals;

acquiring a quantity of second preset intervals, the quantity of second preset intervals being a quantity of divided intervals of an acceleration of the speed at the next moment;

determining, according to the discrete grid space and the quantity of second preset intervals and by using the Markov model, a probability that the acceleration at the current moment changes to the acceleration of the speed at the next moment; and

determining the acceleration of the speed at the next moment according to the probability.

A specific process of the determining, by using the Markov model, a probability that the acceleration at the current moment changes to the acceleration of the speed at the next moment is that:

A random process ω(t) is used to simulate a driving behavior. ω(t) represents a state of the HEV at a moment t. A variable of ω(t) may represent required power, an acceleration, a speed, or a combination of the foregoing variables. All the information can be detected by sensors on the vehicle. The driving behavior at the moment t is unrelated to historical information, and is only determined by current information. Therefore, a change of ω(t) may be considered as a Markov process. In this case, a change law of ω(t) may be simulated by using a Markov model, and a speed at a next moment is predicted.

A discrete grid space is constructed by using a speed v (0 to 36 m/s) and an acceleration a (−1.5 to 1.5 m/s²), and the speed is defined as a current state variable, and is divided into p intervals indexed by i∈{1, . . . , p}. The acceleration of the vehicle is defined as an output variable at the next moment, and is divided into q intervals indexed by j∈{1, . . . , q}. Therefore, a transition probability matrix of the Markov model is:

X_{i,j}=Pr[a(t+1)=aⱼ|v(t)=vᵢ] (1)

In the formula, X_{i,j} represents a probability that an acceleration of the vehicle changes to a₁ at a next moment in a case that a speed is v(t)=vᵢ at a current moment. Therefore, the transition probability matrix may be calculated according to the formula (1):

$${X}_{i , j} = \frac{{N}_{i , j}}{{\sum }_{j = 1}^{q} {N}_{i , j}} \qquad ( 2 )$$

In the formula, N_{i,j} represents a quantity of times of the acceleration of the vehicle being a₁ at the next moment in a case that the speed is vᵢ at the current moment.

According to the Markov model, the acceleration of the vehicle at the next moment may be predicted at the current moment, and the speed at the next moment is obtained:

v(t+1)=v(t)+Σⱼ₌₁^{q}(aⱼ(t+1)·T_{v(t),j}) (3)

where T_{v(t),j} is a prediction period.

In S103, the determining battery power of the HEV according to the required power of the HEV at the next moment and the engine power specifically includes:

acquiring power consumed by a friction brake of the HEV in a case of insufficient regenerative braking; and

determining, according to the required power of the HEV at the next moment, the engine power, and the power consumed by the friction brake, the battery power P_{ba}(k) of the HEV by using a formula P_{ba}(k)=P_{req}(k)−P_{eng}(k)+Pₘᵢₛₛ(k) (formula (4)). P_{req}(k) is the required power at the next moment, and may be calculated according to the speed and the acceleration predicted by using the Markov model in S101; and P_{eng}(k) is the engine power, and a power change thereof is shown in formula (5):

ΔP_{neg}(t)=P_{neg}(t+1)−P_{neg}(t) (5)

Pₘᵢₛₛ(k) is the power consumed by the friction brake, and Pₘᵢₛₛ(k)≥0.

In S104, an SOE of the battery is used to describe a state of the battery, where SOE=1 indicates that the battery is fully charged, and SOE=0 indicates that the battery is fully discharged. When Pₘᵢₛₛ(k)>0, the battery is discharged, and when Pₘᵢₛₛ(k)<0, the battery is charged. A dynamic model thereof is:

SOE(k+1)=SOE(k)−P_{ba}(k) (6)

where SOE(⋅) is the dynamic model for battery charging/discharging, P_{ba}(k) is the battery power, and k=−Δt/E_{ba}, Δt being a simulation step size, and E_{ba} being total battery energy.

In a predicted domain, the constructed energy optimization scheduling model of the HEV in S106 is:

min G=Σₜ₌₁ⁿ{ω₁Cₒᵢₗ(t)+ω₂Fₒᵢₗ(t)+ω₃M_{co}_{₂}(t)} (7)

where G is an energy optimization target, Cₒᵢₗ(t) is the fuel costs, Fₒᵢₗ(t) is the costs of electric energy consumption,

M_{co}_{₂}(t) is a lowest value of emission of carbon dioxide (CO₂), ω₁ is a weight of the fuel costs, ω₂ is a weight of the costs of electric energy consumption, ω₃ is a weight of the lowest value of the emission of carbon dioxide, ω₁+ω₂+ω₃=1, t is a moment, and n is a total quantity of moments.

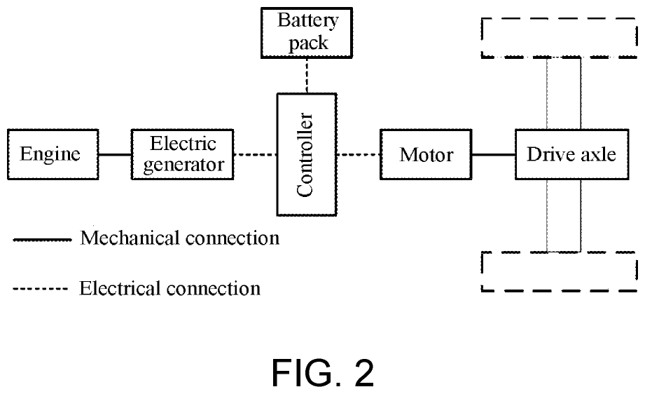

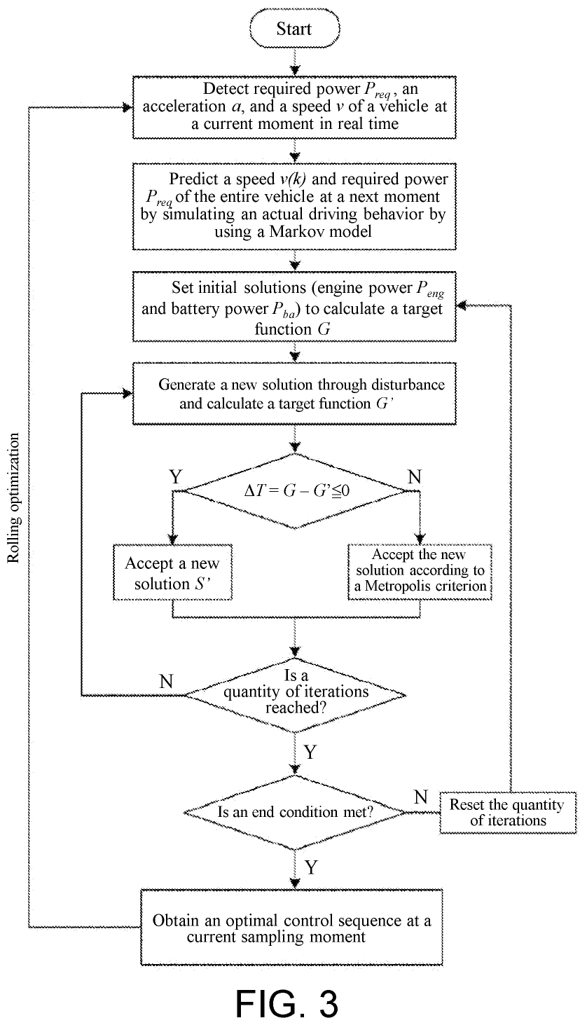

According to another embodiment of the present invention, based on a structure of a hybrid power system disclosed in FIG. 2, the energy management method for an HEV provided in the present invention may further include the following processes (as shown in FIG. 3):

First, a state equation that reflects a real system is established based on the structure of the hybrid power system, a state variable is used to represent a possible driving behavior of a driver, a state transition matrix is used to simulate a behavior of the driver during actual driving, and a Markov model is used to calculate a torque state transition probability, to obtain a predicted speed in a predicted time domain.

Then, an HEV optimization control model is constructed by taking lowest energy consumption, fuel costs, and emission of CO₂ in a predicted domain as a comprehensive optimization target.

Last, rolling optimization is performed on the model by using a simulated annealing algorithm, that is, at each sampling moment, a first item of an optimal control sequence is used as an input variable of the system, and the solution process is repeated at a next moment to obtain a control amount at the next moment, so that real-time optimal control of the HEV is finally achieved.

A process of performing the rolling optimization by using the simulated annealing algorithm specifically includes:

As a general random search algorithm, the simulated annealing algorithm is mainly used to solve a problem of local optimal solution, and can be decomposed into three parts: a solution space, a target function, and an initial solution.

(1) Initialization: For an initial temperature T (sufficiently large), T=α*T, α∈(0,1), to ensure a relatively large search space, α generally takes a value close to 1, for example, 0.95.

An initial solution state S (S being a starting point of algorithm iteration) and a preset quantity of iterations L corresponding to each T value are acquired.

(2) Let k=1, . . . , and let L repeat steps (3) to (6).

(3) A new solution S is generated.

(4) An increment ΔT=G(S^{η})−G(S) is calculated, where G(S) is the target function.

(5) If ΔT<0, S^{η} is accepted as a new current solution; otherwise, S^{η} is accepted as the new current solution with a probability exp (−ΔT/T).

(6) If an end condition is met, the current solution is outputted as the optimal solution, and the program of rolling optimization is ended. The end condition is usually a situation that several consecutive new solutions are not accepted.

(7) T decreases gradually, and T approaches 0, and then step (2) is performed.

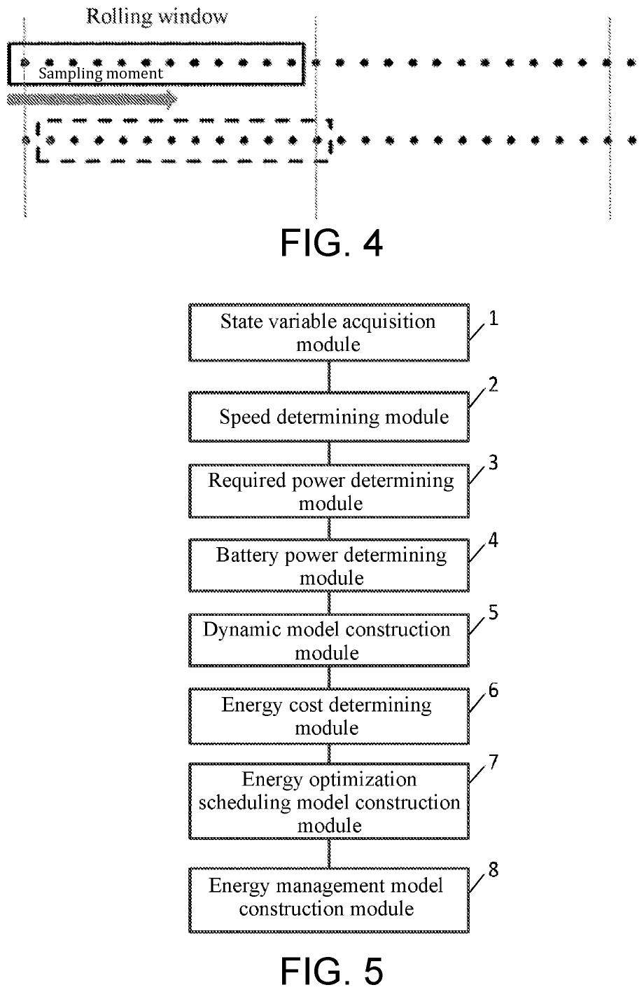

At each sampling moment, according to obtained current information, for example, real-time information such as an acceleration, a speed, and required power of the vehicle during driving, the simulated annealing algorithm is substituted into an established system model for solving online, to obtain a finite-time open-loop optimal control sequence, namely S^{η}; and a first element S^{η}(1) of S^{η} is applied to a controlled object. The foregoing process is repeated in a next sampling moment, and so on, FIG. 4 is a schematic diagram of a rolling solving process.

The technical solution provided in the present invention has the following advantages:

In consideration of lack of real-time performance and randomness of the vehicle in an actual driving process in a conventional HEV control policy, according to the present invention, a speed is predicted by using a Markov model; and by simplifying a control model and using comprehensive optimized performances of fuel economy, energy consumption, and emission of CO₂ in a predicted domain as a target, a target function is solved by using a simulated annealing algorithm. A calculation time is short, and adverse effects of random characteristics thereof on driving safety and performance are effectively avoided.

In addition, for the energy management method for an HEV disclosed in the present invention, the present invention further correspondingly provides an energy management system for an HEV, and a specific structure thereof is shown in FIG. 5. The energy management system for an HEV includes: a state variable acquisition module 1, a speed determining module 2, a required power determining module 3, a battery power determining module 4, a dynamic model construction module 5, an energy cost determining module 6, an energy optimization scheduling model construction module 7, and an energy management model construction module 8.

The state variable acquisition module 1 is configured to acquire a state variable of an HEV, the state variable including: a speed at a current moment, an acceleration at the current moment, and engine power.

The speed determining module 2 is configured to determine, according to the speed at the current moment and the acceleration at the current moment, a speed of the HEV at a next moment by using a Markov model.

The required power determining module 3 is configured to determine required power of the HEV at the next moment according to the speed of the HEV at the next moment.

The battery power determining module 4 is configured to determine battery power of the HEV according to the required power of the HEV at the next moment and the engine power.

The dynamic model construction module 5 is configured to construct a dynamic model for battery charging/discharging according to the battery power.

The energy cost determining module 6 is configured to determine energy costs of the HEV according to the required power at the next moment, the energy costs including fuel costs and costs of electric energy consumption.

The energy optimization scheduling model construction module 7 is configured to construct an energy optimization scheduling model of the HEV according to the energy costs.

The energy management model construction module 8 is configured to determine an energy management model of the HEV according to the energy optimization scheduling model and the dynamic model for battery charging/discharging, to manage energy of the HEY.

The speed determining module 2 specifically includes: a discrete grid space construction unit, a second-preset-interval-quantity acquisition unit, an acceleration probability determining unit, an acceleration determining unit, and a speed determining unit.

The discrete grid space construction unit is configured to construct a discrete grid space according to the speed at the current moment and the acceleration at the current moment and based on a quantity of first preset intervals.

The second-preset-interval-quantity acquisition unit is configured to acquire a quantity of second preset intervals, the quantity of second preset intervals being a quantity of divided intervals of an acceleration of the speed at the next moment.

The acceleration probability determining unit is configured to determine, according to the discrete grid space and the quantity of second preset intervals and by using the Markov model, a probability that the acceleration at the current moment changes to the acceleration of the speed at the next moment.

The acceleration determining unit is configured to determine the acceleration of the speed at the next moment according to the probability.

The speed determining unit is configured to determine the speed of the HEV at the next moment according to the acceleration of the speed at the next moment.

The battery power determining module 4 specifically includes: a power-consumed-by-friction-brake acquisition unit and a battery power determining unit.

The power-consumed-by-friction-brake acquisition unit is configured to acquire power consumed by a friction brake of the HEV in a case of insufficient regenerative braking.

The battery power determining unit is configured to determine, according to the required power of the HEV at the next moment, the engine power, and the power consumed by the friction brake, the battery power P_{ba}(k) of the HEV by using a formula P_{ba}(k)=P_{req}(k)−P_{eng}(k)+Pₘᵢₛₛ(k). P_{req}(k) is the required power at the next moment, P_{eng}(k) is the engine power, and Pₘᵢₛₛ(k) is the power consumed by the friction brake.

The embodiments in this specification are all described in a progressive manner. Description of each of the embodiments focuses on differences from other embodiments, and reference may be made to each other for the same or similar parts among the embodiments. The system disclosed in the embodiments is described relatively simply because it corresponds to the method disclosed in the embodiments, and for portions related to those of the method, reference may be made to the description of the method.

The principle and implementations of the present invention are described herein through specific examples. The description about the embodiments is merely provided to help understand the method and core ideas of the present invention. In addition, a person of ordinary skill in the art can make variations and modifications to the present invention in terms of the specific implementations and application scopes according to the ideas of the present invention. In conclusion, content herein should not be understood as a limitation to the present invention.

1. An energy management method for a hybrid electric vehicle (HEV), comprising:
acquiring a state variable of an HEV, the state variable comprising: a speed at a current moment, an acceleration at the current moment, and engine power;
determining, according to the speed at the current moment and the acceleration at the current moment, a speed of the HEV at a next moment by using a Markov model;
determining required power of the HEV at the next moment according to the speed of the HEV at the next moment;
determining battery power of the HEV according to the required power of the HEV at the next moment and the engine power;
constructing a dynamic model for battery charging/discharging according to the battery power;
determining energy costs of the HEV according to the required power at the next moment, the energy costs comprising fuel costs and costs of electric energy consumption;
constructing an energy optimization scheduling model of the HEV according to the energy costs; and
determining an energy management model of the HEV according to the energy optimization scheduling model and the dynamic model for battery charging/discharging, to manage energy of the HEV.

2. The energy management method for an HEV according to claim 1, wherein the determining, according to the speed at the current moment and the acceleration at the current moment, a speed of the HEV at a next moment by using a Markov model specifically comprises:
constructing a discrete grid space according to the speed at the current moment and the acceleration at the current moment and based on a quantity of first preset intervals;
acquiring a quantity of second preset intervals, the quantity of second preset intervals being a quantity of divided intervals of an acceleration of the speed at the next moment;
determining, according to the discrete grid space and the quantity of second preset intervals and by using the Markov model, a probability that the acceleration at the current moment changes to the acceleration of the speed at the next moment;
determining the acceleration of the speed at the next moment according to the probability; and
determining the speed of the HEV at the next moment according to the acceleration of the speed at the next moment.

3. The energy management method for an HEV according to claim 1, wherein the determining battery power of the HEV according to the required power of the HEV at the next moment and the engine power specifically comprises:
acquiring power consumed by a friction brake of the HEV in a case of insufficient regenerative braking; and
determining, according to the required power of the HEV at the next moment, the engine power, and the power consumed by the friction brake, the battery power P_{ba}(k) of the HEV by using a formula P_{ba}(k)=P_{req}(k)−P_{eng}(k)+Pₘᵢₛₛ(k), wherein P_{req}(k) is the required power of the HEV at the next moment, P_{eng}(k) is the engine power, and Pₘᵢₛₛ(k) is the power consumed by the friction brake.

4. The energy management method for an HEV according to claim 1, wherein the dynamic model for battery charging/discharging is:
SOE(k+1)=SOE(k)−P_{ba}(k), wherein SOE(⋅) is the dynamic model for battery charging/discharging, P_{ba}(k) is the battery power, and k=−Δt/E_{ba}, Δt being a simulation step size, and E_{ba} being total battery energy.

5. The energy management method for an HEV according to claim 1, wherein the energy optimization scheduling model of the HEV is:
min G=Σₜ₌₁ⁿ{ω₁Cₒᵢₗ(t)+ω₂Fₒᵢₗ(t)+ω₃M_{co}_{₂}(t)}, wherein G is an energy optimization target, Cₒᵢₗ(t) is the fuel costs, Fₒᵢₗ(t) is the costs of electric energy consumption, M_{co}_{₂}(t) is a lowest value of emission of carbon dioxide (CO₂), ω₁ is a weight of the fuel costs, ω₂ is a weight of the costs of electric energy consumption, ω₃ is a weight of the lowest value of the emission of carbon dioxide, ω₁+ω₂+ω₃=1, t is a moment, and n is a total quantity of moments.

6. An energy management system for a hybrid electric vehicle (HEV), comprising:
a state variable acquisition module, configured to acquire a state variable of an HEV, the state variable comprising: a speed at a current moment, an acceleration at the current moment, and engine power;
a speed determining module, configured to determine, according to the speed at the current moment and the acceleration at the current moment, a speed of the HEV at a next moment by using a Markov model;
a required power determining module, configured to determine required power of the HEV at the next moment according to the speed of the HEV at the next moment;
a battery power determining module, configured to determine battery power of the HEV according to the required power of the HEV at the next moment and the engine power;
a dynamic model construction module, configured to construct a dynamic model for battery charging/discharging according to the battery power;
an energy cost determining module, configured to determine energy costs of the HEV according to the required power at the next moment, the energy costs comprising fuel costs and costs of electric energy consumption;
an energy optimization scheduling model construction module, configured to construct an energy optimization scheduling model of the HEV according to the energy costs; and
an energy management model construction module, configured to determine an energy management model of the HEV according to the energy optimization scheduling model and the dynamic model for battery charging/discharging, to manage energy of the HEV.

7. The energy management system for an HEV according to claim 6, wherein the speed determining module specifically comprises:
a discrete grid space construction unit, configured to construct a discrete grid space according to the speed at the current moment and the acceleration at the current moment and based on a quantity of first preset intervals;
a second-preset-interval-quantity acquisition unit, configured to acquire a quantity of second preset intervals, the quantity of second preset intervals being a quantity of divided intervals of an acceleration of the speed at the next moment;
an acceleration probability determining unit, configured to determine, according to the discrete grid space and the quantity of second preset intervals and by using the Markov model, a probability that the acceleration at the current moment changes to the acceleration of the speed at the next moment;
an acceleration determining unit, configured to determine the acceleration of the speed at the next moment according to the probability; and
a speed determining unit, configured to determine the speed of the HEV at the next moment according to the acceleration of the speed at the next moment.

8. The energy management system for an HEV according to claim 1, wherein the battery power determining module specifically comprises:
a power-consumed-by-friction-brake acquisition unit, configured to acquire power consumed by a friction brake of the HEV in a case of insufficient regenerative braking; and
a battery power determining unit, configured to determine, according to the required power of the HEV at the next moment, the engine power, and the power consumed by the friction brake, the battery power P_{ba}(k) of the HEV by using a formula P_{ba}(k)=P_{req}(k)−P_{eng}(k)+Pₘᵢₛₛ(k), wherein P_{req}(k) is the required power at the next moment, P_{eng}(k) is the engine power, and Pₘᵢₛₛ(k) is the power consumed by the friction brake.
